(19) United States
(12) Patent Application Publication
(10) Pub. No.: US 2004/0023625 A1
(43) Pub. Date: Feb. 5, 2004

(54) Frequency synthesizer and a method for synthesizing a frequency

(76) Inventor: Fredrik Jonsson, Stockholm (SE)

Correspondence Address: HARNESS, DICKEY & PIERCE, P.L.C., P.O. BOX 8910, RESTON, VA, 20195, US

(21) Appl. No.: 10/399,963

(22) PCT Filed: Oct. 22, 2001
(86) PCT No.: PCT/SE01/02314

(30) Foreign Application Priority Data
Oct. 23, 2000 (SE) 0003872-9

(51) Int. Cl. H04B 1/04; H01Q 11/12

(52) U.S. Cl. 455/121

(57) ABSTRACT

This invention relates to a method of synthesizing a frequency by means of a frequency synthesizer comprising a local oscillator, which generates an output signal, a phase locked loop, which provides a control signal to the local oscillator, and a frequency divider, which divides the frequency of said output signal and provides a frequency divided input signal to the phase locked loop, wherein the method comprises the steps of: providing, in a receiving mode, said output signal to a receiver for tuning thereof; locking, by means of said phase locked loop, the frequency of said output signal to a channel frequency of a channel to be received; and turning off said phase locked loop when said output signal frequency is locked to said channel frequency and keeping the phase locked loop off during a following receive cycle. The invention also relates to a frequency synthesizer and a transceiver respectively, for performing the method.

### TECHNICAL FIELD

This invention relates generally to wireless communication, and more specifically to controlling a frequency synthesizer loop.

### TECHNICAL BACKGROUND

In all wireless communication system, channels located at different frequencies are used. When transmitting or receiving, it is important to set the frequency of the channel accurately, in order not to interfere with other channels at nearby frequencies. In order to achieve a precise frequency, a frequency synthesizer comprising a Phase Locked Loop (PLL) to lock the local oscillator (LO) to a stable reference frequency is typically used. In many time multiplexed communication systems, like GSM, Bluetooth and DECT, the same frequency synthesizer can be used both during the transmit and the receive cycle. In order to increase the robustness of the channel, modern communication standards are also using frequency hopping. The frequency hopping put high demands on the frequency synthesizer lock time.

However, a drawback of using a PLL to synthesize the frequency is that a fractional part of the reference frequency is fed through the PLL loop filter to the local oscillator, resulting in spurious frequencies in the output spectra of the oscillator (as shown in FIG. 2). Since the PLL has to operate at a high frequency, the circuit also consumes a lot of power.

As to the problem of spurious frequencies attempts have been made to provide a filter which minimizes the spurs in the LO spectrum. One prior art solution is to use a PLL loop filter having a low cut-off frequency, so as to exclude the spurious frequencies. However, while achieving sufficient suppression of the spurs by lowering the cut-off frequency, the frequency settling time is undesirably prolonged. Further, while on one hand a low cut-off frequency is desired, on the other it results in large components, which is undesired in many applications where the circuit size plays an important role.

Since the noise of the PLL loop filter is directly added to the LO phase noise, active filter realisations having component values that can be placed on-chip, are too noisy and cannot be used. On the other hand, a passive filter with a low cut-off frequency is hard to achieve with fully integrated components, which is basically aimed at. This is the reason why most frequency synthesizers use off-chip loop filters, although an on-chip solution would be advantageous.

### SUMMARY OF THE INVENTION

The object of this invention is to provide a solution to the above discussed problem of spurs.

In accordance with the present invention, in a first aspect thereof, there is provided a method of synthesizing a frequency by means of a frequency synthesizer comprising a local oscillator, which generates an output signal, a phase locked loop, which provides a frequency control signal to the local oscillator, and a frequency divider, which divides the frequency of said output signal and provides a frequency divided input signal to the phase locked loop. The method comprises the steps of:

providing, in a receiving mode, said output signal to a receiver for tuning thereof;

locking, by means of said phase locked loop, the frequency of said output signal to a channel frequency of a channel to be received; and

turning off said phase locked loop when said output signal frequency is locked to said channel frequency and keeping the phase locked loop off during a following receive cycle.

In a second aspect of the present invention there is provided a frequency synthesizer comprising a local oscillator, which generates an output signal, a phase locked loop, which provides a frequency control signal to the local oscillator, and a frequency divider, which divides the frequency of said output signal and provides a frequency divided input signal to the phase locked loop. The frequency synthesizer further comprises a control unit, which is arranged to turn said phase locked loop on and off, which is arranged to detect a receiving mode and turn said phase locked loop on for locking the frequency of said output signal to a channel frequency of a channel to be received, and which is arranged to turn off said phase locked loop, when said output signal frequency is locked to said channel frequency and keep the phase locked loop off during a following receive cycle.

In a third aspect of the present invention there is provided a transceiver apparatus comprising the above defined frequency synthesizer.

Consequently, the solution to the above stated object relies on the idea of only using the PLL during frequency lock in, when data is about to be received by a receiver which is tuned to the current channel frequency by means of the frequency synthesizer. This results in an elimination of the spurious frequencies (as shown in FIG. 4). Once the PLL is locked to the correct frequency, the PLL can be turned off during the very receiving cycle, i.e. in a predetermined period during which there is data to be received. Provided that the leakage current is not too high, the PLL loop filter capacitor is able to hold the correct control voltage during the entire receive slot.

Several advantages arise when it is not necessary to take the spurious frequencies into account and some of them are as follows. The requirements on the PLL loop filter can be substantially relaxed, which makes it possible to implement the loop filter on chip. Since we have no spurious frequencies in the spectrum, the phase noise performance is improved. The loop filter bandwidth can be increased, making it possible to achieve faster PLL lock time. Since the PLL only have to be used during a short period of the receive cycle, the power consumption can be reduced.

Referring now to said third aspect, an advantageous use of the frequency synthesizer is in a transceiver apparatus, particularly one that is employed in a wireless mobile device. Among other things, this is due to the reduced power consumption and the smaller sized loop filter. An integration of the transceiver employing the present invention is facilitated in comparison with the prior art solution of a low cut-off frequency loop filter.

Further objects and advantages of the present invention will be discussed below by means of exemplary embodiments.

### BRIEF DESCRIPTION OF THE DRAWING

Exemplifying embodiments of the invention will be described below with reference to the accompanying drawings, in which:

FIG. 1 schematically shows a general transceiver apparatus;

FIG. 2 shows a graph of an oscillator output spectra for a prior art frequency synthesizer;

FIG. 3 shows a graph of an oscillator output spectra for a frequency synthesizer according to the present invention;

FIG. 4 schematically illustrates a frequency synthesizer during frequency lock;

FIG. 5 schematically illustrates a frequency synthesizer in receive cycle; and

FIG. 6 is a schematic diagram of a PLL portion of a frequency synthesizer according to the present invention.

### DESCRIPTION OF EMBODIMENTS

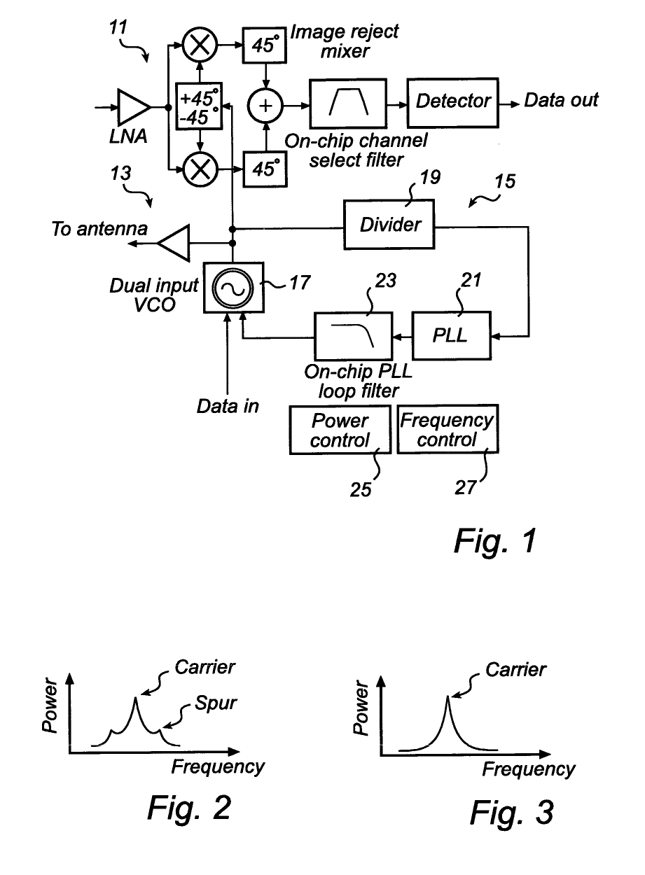

Referring to FIG. 1 a general transceiver architecture comprises a receiver part 11, a transmitter part 13 and a frequency synthesizer 15 used by both receiver part 11 and transmitter part 13. The frequency synthesizer comprises a local oscillator, here represented by a voltage controlled oscillator (VCO) 17, a frequency divider 19, connected to the output of the VCO 17, a phase locked loop (PLL) 21 connected to the output of the divider 19, and a PLL loop filter 23 connected to the output of the PLL 21 and a first input of the VCO 17 respectively. Further, the transceiver comprises power control and frequency control circuits 25 and 27 respectively.

When in a transmitting mode the VCO outputs a carrier, which is modulated by a data signal entered at a second input of the VCO, to the antenna. In a receiving mode the VCO applies a channel signal at a predetermined channel frequency to the receiver part, for tuning the same into one out of many channels. The output frequency of the VCO 17 is controlled by a reference frequency signal fed to the PLL 21 by the frequency control circuit 27. The output signal of the VCO is frequency divided by the divider 19 and fed to the PLL 21, where it is phase compared with the reference frequency signal. The output signal of the PLL is fed through the loop filter 23, which generates an output voltage the level of which determines the output frequency of the VCO 17.

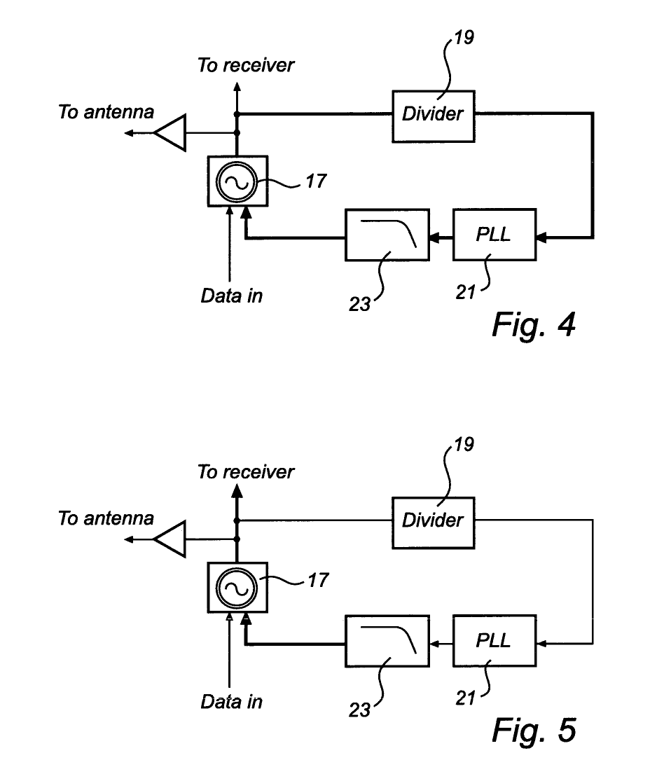

In accordance with this invention, in the receiving mode the PLL is on during an initial frequency locking, as shown by the thick line in FIG. 4. As soon as the frequency is locked, the PLL 21 is turned off, so that during the very receive cycle the loop filter 23 controls the VCO 17 on its own, as shown in FIG. 5. This is possible due to a loop filter capacitor present in all loop filters, which capacitor holds the control voltage during the entire receive cycle, in other words during a receive slot. Inevitably there is a voltage drop due to leakage. However, a man skilled in the art will be able to dimension the loop filter so as to provide for a leakage current which is low enough, taken into account the typical duration of a receive slot as defined by different communication standards like those mentioned above.

To turn off the PLL is per se known for the transmitting mode. However, the VCO output signal frequency is allowed to vary more in the transmitting mode than in the receiving mode. Still, in accordance with the invention, it has proven possible to turn off the PLL 21 also in the receiving mode.

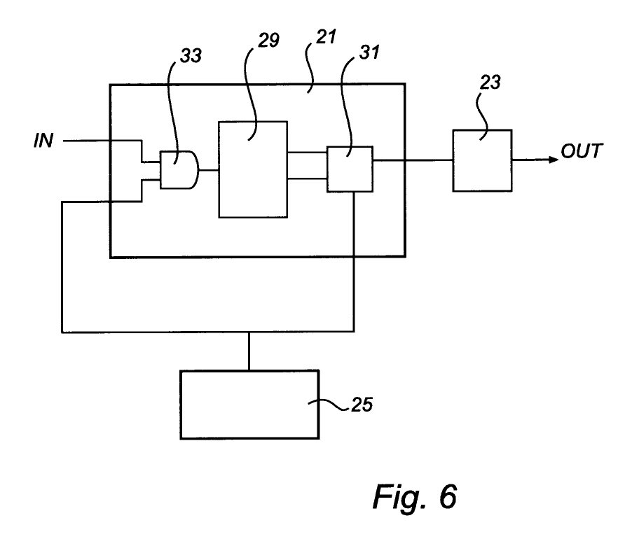

Referring now to FIG. 6 the switching of the PLL 21 is controlled as follows. The very PLL circuit 21 comprises a digital part 29, including a phase comparator, a charge pump 31, having two inputs which are connected to corresponding outputs of the digital part 29, and a control element or switch 33, having an output, connected to an input of the digital part 29, and first and second inputs. In this preferred embodiment the control element 33 is illustrated as an AND gate, which is a simple and reliable implementation. The power control circuit 25 has an enable output, which is connected to the second input of the control element 33 as well as to the charge pump 31. The first input of the control element is connected to the divider 19. During frequency locking the power control outputs an enable signal which is thus fed to the control element 33 and to the charge pump 31. When the frequency of the VCO output signal is correctly locked, the power control circuit enable signal is disabled and consequently the PLL is turned off since the control element 33 does not pass the frequency divided input signal to the digital part 29. Here it is to be noted that it is understood that the digital circuitry is implemented in CMOS technology.

Furthermore, the charge pump 31 is turned off. By actively turning off the charge pump as well, it is secured that the charge pump 31 provides no output signal adding to the frequency drift in the output signal of the VCO 17.

Consequently the output signal of the loop filter is maintained at approximately the same level until the receive cycle is finished and a new frequency locking operation is to be performed. Of course the capacitance of the loop filter capacitor is limited. However, it can easily be given an appropriate capacitance value so as to keep the frequency drift of the VCO output signal within required limits at frequencies which are typical for wireless communication systems.

Above a preferred embodiment of the method according to the present invention has been described. This should be seen as merely a non-limiting example. Many modifications will be possible within the scope of the invention as defined by the claims.

1. A method of synthesizing a frequency by means of a frequency synthesizer comprising a local oscillator, which generates an output signal, a phase locked loop, which provides a control signal to the local oscillator, and a frequency divider, which divides the frequency of said output signal and provides a frequency divided input signal to the phase locked loop, wherein the method comprises the steps of:
providing, in a receiving mode, said output signal to a receiver for tuning thereof;
locking, by means of said phase locked loop, the frequency of said output signal to a channel frequency of a channel to be received; and
turning off said phase locked loop when said output signal frequency is locked to said channel frequency and keeping the phase locked loop off during a following receive cycle.

2. The method of synthesizing a frequency according to claim 1, wherein the step of turning off comprises the step of disabling said frequency divided input signal.

3. The method of frequency synthesizing according to claim 2, wherein said step of turning off further comprises disabling a charge pump, which is comprised in said phase locked loop.

4. A frequency synthesizer comprising a local oscillator, which generates an output signal, a phase locked loop, which provides a frequency control signal to the local oscillator, and a frequency divider, which divides the frequency of said output signal and provides a frequency divided input signal to the phase locked loop, wherein said frequency synthesizer further comprises a control unit, which is arranged to turn said phase locked loop on and off, which is arranged to detect a receiving mode and turn said phase locked loop on for locking the frequency of said output signal to a channel frequency of a channel to be received, and which is arranged to turn off said phase locked loop, when said output signal frequency is locked to said channel frequency and keep the phase locked loop off during a following receive cycle.

5. A frequency synthesizer according to claim 4, wherein said phase locked loop comprises a phase comparator and a control switch, which has a first input connected to said frequency divider for receiving said frequency divided signal, a second input connected to said control unit for receiving an enable signal and an output connected to said phase comparator, wherein said control switch is arranged to be enabled for passing the frequency divided signal or disabled for blocking the frequency divided signal in response to a respective one of two different states of said enable signal.

6. A frequency synthesizer according to claim 5, wherein said phase locked loop further comprises a charge pump, connected to said phase comparator, and a loop filter, connected to said charge pump and to said local oscillator, wherein said charge pump is further connected to said control unit for receiving another enable signal, wherein said charge pump is arranged to be enabled or disabled in response to a respective one of two different states of said another enable signal.

7. A transceiver apparatus comprising a frequency synthesizer according to any one of claims 4-6.
